(19) United States
(12) Patent Application Publication
(10) Pub. No.: US 2008/0105198 A1
(43) Pub. Date: May 8, 2008

(54) Applicator device for a printing/varnishing unit in a processing machine

(75) Inventors: Thomas Walther, Hofheim (DE); Robert Ortner, Alzenau (DE); Jurgen Scholzig, Mainz (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: MAN Roland Druckmaschinen AG, Offenbach am Main (DE)

(21) Appl. No.: 12/005,588

(22) Filed: Dec. 27, 2007

Related U.S. Application Data
(62) Division of application No. 10/517,900, filed on Jul. 21, 2005.

(30) Foreign Application Priority Data
Jun. 11, 2002 (DE) 10225739.6

(51) Int. Cl. B05C 1/08

(52) U.S. Cl. 118/258

(57) ABSTRACT

An applicator device for a printing/varnishing unit in a processing machine is provided. The applicator device helps prevent jolts caused by a cylinder channel and thereby increasing the print quality. The applicator roller 5, 6, 7 is associated with a cylinder channel 10 of a printing cylinder 1. The applicator roller 5, 6, 7 consists of a roller core 12 on which at least one compressible layer 13 and a cover layer 14 are concentrically arranged.

### CROSS-REFERENCE TO RELATED APPLICATIONS

This patent application is a divisional of copending U.S. patent application Ser. No. 10/517,900.

### FIELD OF THE INVENTION

The invention pertains to an applicator device for a printing/varnishing unit in a processing machine and more particularly in a printing machine with printing units that is combined with at least one varnishing unit or a varnishing machine with at least one varnishing unit.

### BACKGROUND OF THE INVENTION

An applicator unit for a printing/varnishing unit is disclosed in EP-0 090 179 B1 that prevents roller marks (in the printed result) in a roller unit of a printing machine. Such roller marks result, for example, from jolts that arise in the rotation of the rollers with a plate cylinder having at least one cylinder channel. In order to guarantee an optimally uniform compressive strain between the plate cylinder and an applicator roller the applicator roller is seated by way of spring loaded pressure members against an adjacent upstream roller. Spring-loaded pressure members are also provided for this upstream roller. The spring forces of all the pressure members are designed such that the bearing play for the applicator roller is shifted to the side facing away from the upstream roller and for the upstream roller to the side facing away from the applicator roller. The disadvantages with this arrangement are the relatively high component costs and the insufficient damping behavior at higher machine speeds and/or larger format widths of the material to be printed.

DE 93 10 713.7 U1 discloses an ink-applicator roller that is operatively connected to a printing cylinder with a tension channel, and that rolls over the printing cylinder with high damping and in a nearly shock-free manner. To this end, the roller bears an elastic roller coating as an ink-carrying cover layer on a core. The contour of the roller core has a cutback (recess) associated with the tension channel of the printing cylinder. The cutback being filled by a thickened part of the roller coating. The ink-applicator roller in this case has a completely cylindrical outer surface. The high manufacturing costs and the fact that the thickened part of the roller coating must always run synchronously with the tension channel are disadvantages of this arrangement. Moreover, the achievable damping is insufficient at higher machine speeds and/or larger format widths of the material to be printed.

### BRIEF SUMMARY OF THE INVENTION

In view of the foregoing, an object of the invention is creating an applicator device that avoids the above-cited disadvantages and which reduces the occurrence of jolts from the passing of a cylinder channel and further increases the print quality.

A first advantage of the invention is based on the fact that the applicator device includes at least one applicator roller and substantially dampens against jolts resulting from the passage of a cylinder channel. By virtue of the construction of the applicator device, no shocks, or very negligible shocks, are transferred into the adjacent roller groups or cylinders. Moreover, the formation of roller strips on the printed product is avoided, and thus an increase in the printing quality (or varnishing quality) can be realized.

It is also advantageous that the applicator device with at least one applicator roller of the invention permits the processing machine to be operated at high speeds, particularly for large formats of material to be printed, without any shocks.

An additional advantage of the invention is that the applicator device with at least one applicator roller can be used universally on processing machines with at least one printing roller and at least one cylinder channel. The applicator device preferably can be used on inking units, especially offset and/or flexographic inking units. In offset printing assisted by moistening agents, the applicator device also can be used in moistening units. The applicator device also can be used in varnishing and flexographic printing units. In that the applicator device is always operatively connected to a printing cylinder or a plate cylinder with preferably at least one cylinder channel.

It is also advantageous that the applicator device with at least one applicator roller of the invention can be driven, preferably in the inking unit and/or moistening unit, at a speed differing from that of the printing cylinder. In such a case, the applicator roller can be driven in a nonpositive manner by the printing cylinder, and the adjacent roller, e.g. the friction roller can be driven in a positive manner.

Finally, it is advantageous that at least one applicator roller of the applicator device of the invention can comprise a layer that is compressible over the entire periphery of the roller while rolling. In particular, the applicator roller can comprise a roller core on which the compressible layer is concentrically arranged adhesively, and a cover layer bearing the material to be processed (ink, varnish, moistening agent) that is concentrically arranged adhesively on the compressible layer.

With the passage of a cylinder channel, an applicator roller having such a construction dips into the latter and into the channel edges. The compressible layer of the applicator roller has a sufficient restoring force so that, after the passage of the cylinder channel, including the channel start, the basic roller position, particularly the predetermined roller strip (roller placement) can again be assumed on the adjacent printing cylinder.

The compressible layer of the applicator roller can consist of a foamed material with a cellular structure. The pore diameter of a cell preferably is approximately 0.1-5 mm. The structure can be closed-cell, i.e., the individual cells form closed cavities, or open-cell, i.e., the cells are connected to one another. Alternatively, a foamed material with mixed-cell structure can be used.

### DESCRIPTION OF THE DRAWINGS

FIG. 1 is a schematic diagram of an exemplary offset printing unit including an applicator roller in accordance with the invention.

FIG. 2 is a schematic diagram of an exemplary varnishing unit including an applicator roller in accordance with the invention.

FIG. 3 is a cross-sectional view of an exemplary applicator roller according to the invention.

### DETAILED DESCRIPTION OF THE INVENTION

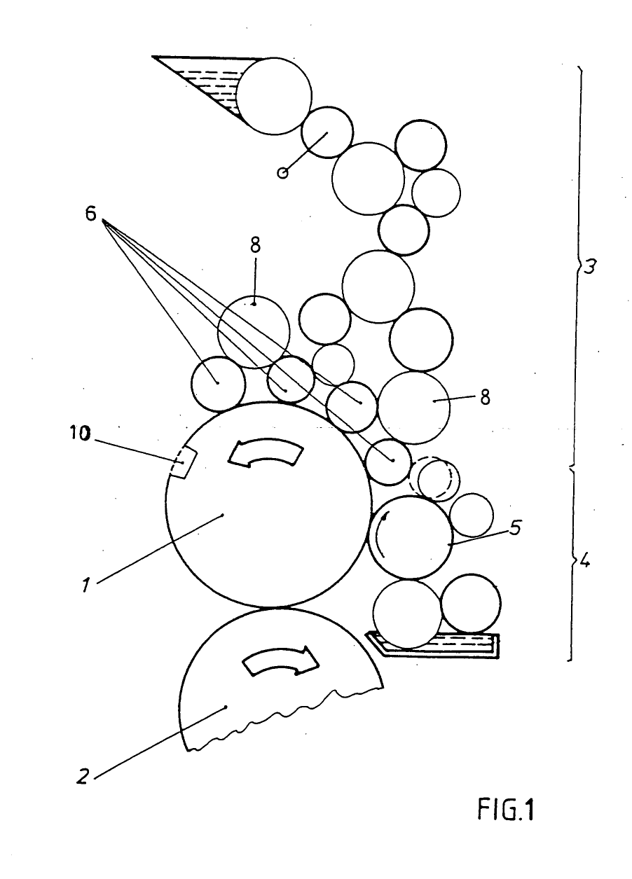

According to FIG. 1, an offset printing unit with an inking unit 3 and, as desired, a moistening unit 4 is shown. Among other components, the inking unit 3 comprises at least one roller train having at its end several applicator rollers comprising ink-applicator rollers 6. Upstream of the ink-applicator rollers 6 are axially moveable and rotationally drivable friction rollers 8.

In the illustrated embodiment, four ink-applicator rollers 6 are in frictional contact with the periphery of a printing cylinder 1, constructed in this case as a plate cylinder. The first and second ink-applicator rollers 6 in the direction of rotation of the printing cylinder 1 are jointly in frictional contact with an upstream first friction roller 8 and the third and fourth application rollers 6 are jointly in frictional contact with an upstream second friction roller 8.

The printing cylinder 1 has at least one cylinder channel 10 arranged parallel to its axis, for receiving, for instance, a tensioning mechanism for the fixation of printing forms. The printing cylinder 1 is additionally in contact with a rubber blanket cylinder 2 and the rubber blanket cylinder 2 is in contact with a pressure cylinder (not shown) such as a sheet-guidance cylinder, which guides the material to be printed.

As needed in, for instance, moistening agent-assisted offset printing, a moistening unit 4 is situated upstream of the inking unit 3 in the direction of rotation of the printing cylinder 1. The moistening unit 4 has at least one applicator roller comprising a moisture-applicator roller 5 that can be brought into contact with the printing cylinder 1 and which is operatively connected to a moistening agent metering system.

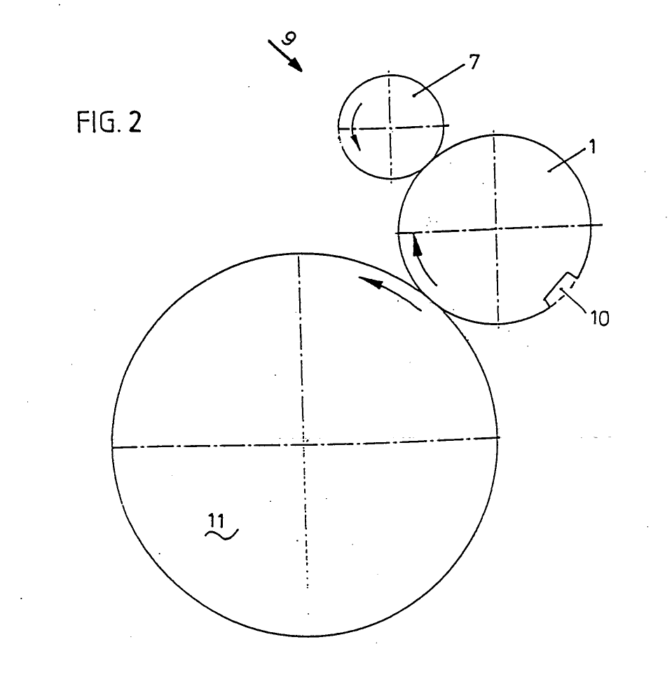

In FIG. 2, a varnishing unit, or, alternatively, a flexographic printing unit is shown, having a printing cylinder 1 with at least one cylinder channel 10 and a pressure cylinder 11, such as a sheet-guidance cylinder, that is operatively connected to the printing cylinder 1.

The printing unit illustrated in FIG. 2 comprises at least one applicator roller that can be brought into contact with printing cylinder 1; it serves as a varnish-applicator roller 7, which is coupled with a metering system 9 for the medium to be processed (flexographic ink, varnish), for instance, a doctor-blade or roller system.

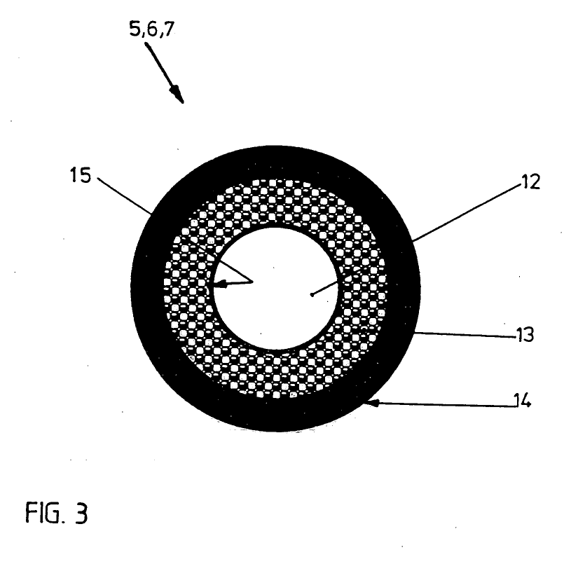

In FIG. 3, an applicator roller (which can be the moisture-applicator roller 5 of FIG. 1, the ink-applicator roller 6 of FIG. 1, or the varnish-applicator roller 7 of FIG. 2) is shown in cross section. This applicator roller 5, 6, 7 possesses a roller core 12 (with roller journals arranged at its ends) as support material.

A compressible layer 13 is tightly adhered concentrically on the roller core 12; in turn, a cover layer 14 carrying the actual medium (ink, varnish, moistening agent) is tightly adhered concentrically on the compressible layer 13. The compressible layer 13 preferably has an open-cell or closed-cell construction. Alternatively, a mixed-cell, foamed material can be used. Moreover, compressible layer 13 can be designed to have bubble-shaped or channel-shaped air or gas inclusions.

The cover layer 14 consists of an elastomeric material, preferably a rubber material carrying ink, varnish or moistening agent.

The compressible material 13 that is formed from a cellular foamed material can be firmly adhered to roller core 12, preferably by means of a first vulcanization. For example, sponge rubber can be employed as such a foamed material. The flexible cover layer 14 arranged concentrically on the compressible layer 13 can then be firmly adhered to this layer 13, preferably by means of a second vulcanization. With the preferred vulcanizations of the foamed material (layer 13) to the roller core 12, and of the cover layer 14 on the foamed material (layer 13), cross-linking reactions occur, so that the tightly adhesive arrangements are formed in each case by an infinitely large network of molecules.

The cover layer 14 is preferably an elastic rubber material with wetting properties that are customary for ink, moistening agent or varnish rollers. The cover layer 14 is preferably an elastic rubber material with a hardness of roughly 20-40 Shore A.

The layer structure of the applicator roller 5, 6, 7 can be configured such that, in a further embodiment, at least one ply of a fabric or a plastic, such as a film, can also be firmly adhered between the compressible layer 13 and the cover layer 14 and/or between the compressible layer 13 and the roller core 12. Preferably, the ply between roller core 12 and compressible layer 13 is a concentrically arranged barrier layer 15 of, for instance, a rubber material.

In another embodiment, the applicator roller 5, 6, 7 can be constructed as a casing and can be pulled on and off the roller core 12 as a sleeve. The casing is preferably constructed of metal or plastic. The compressible layer 13 and the cover layer 14 are each in turn firmly adhered in concentric relation to the sleeve.

According to a further embodiment of the invention, at least one ply of a fabric or plastic material such as a film is also firmly adhered between the sleeve and compressible layer 13 and/or between the compressible layer 13 and the cover layer 14.

Preferably a ply arranged between the roller core 12 and the compressible layer 13 is a concentrically arranged barrier layer 15 of, for instance, a rubber material.

The barrier layer 15 preferably serves as an adhesive layer that improves the joining of the compressible layer 13 to the roller core 12 or to the sleeve. Additionally, the uniform arrangement of the air or gas inclusions in the foam material inside the compressible layer 13 is supported.

When the applicator roller is embodied as an ink-applicator roller 6 in the inking unit 3 such as shown in FIG. 1 the arrangement is such that at least one of the four ink-applicator rollers 5 is constructed with a compressible layer 13 and the remaining ink-applicator rollers are constructed without a compressible layer 13. All four ink-applicator rollers of the FIG. 1 arrangement preferably comprise the compressible layer 13, which noticeably increases the damping effect.

In another embodiment, at least the first and second (alternatively, the third and fourth) ink-applicator rollers 6 associated with the joint friction roller 8 are constructed with a compressible layer 13 and a cover layer 14 firmly adhered thereon.

The applicator roller construction of the invention is not limited to an ink-applicator roller 6 of an inking unit 3. In another embodiment, a moistening-applicator roller 5 of a moistening unit 4 such as shown in FIG. 1 is constructed with a roller core 12 and a compressible layer 13 arranged concentrically and firmly adhered thereto, as well as an elastic cover layer 14 firmly adhered to the compressible layer 13.

For printing units with inking and moistening units 3, 4, a combination of moisture-applicator rollers 5 and ink-applicator rollers 6 having this compressible layer structure, composed of a roller core 12, a compressible layer 13 and an elastic cover layer 14, can be provided for each printing unit.

For varnishing units, a varnish-applicator roller 7 such as shown in FIG. 2 can be configured with this compressible layer structure, formed of a roller core 12, a compressible layer 13 and an elastic cover layer 14. A metering system 9 can also be arranged before the varnish-applicator roller 7. The metering system 9 preferably comprises a screen roller in contact with the varnish-applicator roller 7 and a chamber doctor blade connected to the screen roller.

Alternatively, the varnish-applicator roller 7 can be part of a pinch-roller or scoop-roller system.

The operation of a processing machine incorporating the invention is as follows:

When the processing machine is in operation, the printing cylinder 1 rotates in the direction of rotation (direction of the arrow in FIG. 1) so that at least one of the applicator rollers 5, 6, 7 rolls over the printing cylinder 1. When the cylinder channel 10 passes the point of contact with at least one of the applicator rollers 5, 6, 7, the jolt initiated by the edge of the cylinder channel is almost completely compensated as a result of the layer structure, particularly compressible layer 13, of the applicator roller 5, 6, 7.

### LIST OF REFERENCE NUMBERS

Printing cylinder (plate cylinder)
Rubber blanket cylinder
Inking unit
Moistening unit
Moisture-applicator roller
Ink-applicator roller
Varnish-applicator roller
Friction roller
Metering system
Cylinder channel
Pressure cylinder
Roller core
Compressible layer
Cover layer
Barrier layer

What is claimed is:

1. A printing machine comprising:
a printing cylinder having a cylinder channel, an applicator device for applying a liquid medium to the printing cylinder, said applicator device including an applicator roller in rolling contact with said printing cylinder, said applicator roller including a roller core, a compressible layer of cellular foam material arranged in concentric relation to the roller core and firmly adhered to the roller core, and an elastic cover layer for carrying a medium to be processed, the elastic cover layer being firmly adhered on the compressible layer, and
said compressible layer being deformable as an incident to said applicator roller contacting said printing cylinder channel during operation of said printing machine for dampening against jolts resulting from rolling movement of the applicator roller surface over the printing cylinder channel.

2. The printing machine according to claim 1, wherein the applicator roller is a moisture-applicator in contact with the printing cylinder operable for applying a moistening agent to said printing cylinder.

3. The printing machine according to claim 1, wherein the applicator roller is an ink-applicator roller in contact with the printing cylinder operable for applying a printing ink to said printing cylinder.

4. The printing machine according to claim 3, wherein the applicator roller is one of a plurality of applicator rollers associated with the printing cylinder, and wherein a first applicator roller and a second applicator roller arranged in a rotational direction of the printing cylinder are in contact with a friction roller.

5. The printing machine according to claim 1, wherein the applicator roller is a varnish-applicator roller in contact with the printing cylinder operable for applying a varnish to said printing cylinder.

6. The printing machine according to claim 1, wherein the compressible layer of the applicator roller is an open-pore foam material.

7. The printing machine according to claim 1, wherein the compressible layer of the applicator roller is a closed-pore foam material.

8. The printing machine according to claim 1, wherein the compressible layer of the applicator roller comprises a combination of open-pore and closed-pore foam materials.

9. The printing machine according to claim 1, wherein the compressible layer of the foamed material includes gas inclusions.

10. The printing machine according to claim 1, wherein the cover layer is arranged on the compressible layer such that the compressible layer and cover layer can be pulled on the roller core as a sleeve.

11. The printing machine according to claim 1, wherein the applicator roller further includes a barrier layer arranged between the roller core and the compressible layer.

12. The printing machine according to claim 1, wherein the applicator roller further includes a barrier layer arranged between the compressible layer and the casing.

13. The printing machine according to claim 10, wherein the compressible layer is firmly adhered on the roller core by a first vulcanization and the cover layer is firmly adhered to the compressible layer by a second vulcanization.

14. An offset printing machine comprising:
a printing cylinder for receiving and supporting a printing form, said printing cylinder having a cylinder channel, an applicator device for applying a liquid medium to the printing form on said printing cylinder, a blanket cylinder in rolling contacting relation with the printing cylinder for receiving liquid medium from the printing cylinder for application to moving sheet material, said applicator device including an applicator roller in rolling contact with said printing cylinder, said applicator roller including a roller core, a compressible layer of cellular foam material arranged in concentric relation to the roller core and firmly adhered to the roller core, and an elastic cover layer for carrying a medium to be processed, the elastic cover layer being firmly adhered on the compressible layer, and said compressible layer being deformable as an incident to said applicator roller contacting said printing cylinder channel during operation of said printing machine for dampening against jolts resulting from rolling movement of the applicator roller surface over the printing cylinder channel.

15. A flexographic printing machine comprising:
a printing cylinder for receiving and supporting a flexographic printing plate, said printing cylinder having a cylinder channel, an applicator device for applying a liquid medium to the printing plate on said printing cylinder, a pressure cylinder in rolling contacting relation with said printing cylinder for defining a printing nip through which sheet material to be printed is directed, said applicator device including an applicator roller in rolling contact with said printing cylinder, said applicator roller including a roller core, a compressible layer of cellular foam material arranged in concentric relation to the roller core and firmly adhered to the roller core, and an elastic cover layer for carrying a medium to be processed, the elastic cover layer being firmly adhered on the compressible layer, and said compressible layer being deformable as an incident to said applicator roller contacting said printing cylinder channel during operation of said printing machine for dampening against jolts resulting from rolling movement of the applicator roller surface over the printing cylinder channel.
